(19) United States
(12) Patent Application Publication
(10) Pub. No.: US 2025/0042410 A1
(43) Pub. Date: Feb. 6, 2025

(54) Device And Method For Controlling Travel

(71) Applicants: Hyundai Motor Company, Seoul (KR); Kia Corporation, Seoul (KR)

(72) Inventors: Yong Suk Kang, Seoul (KR); Dong Hwi Lee, Seongnam-Si (KR); Woo Seok Ro, Gunpo-Si (KR); Chang Young Jung, Seoul (KR); Keon Chang Lee, Hwaseong-Si (KR)

(21) Appl. No.: 18/618,089

(22) Filed: Mar. 27, 2024

(30) Foreign Application Priority Data
Jul. 31, 2023 (KR) 10-2023-0099888

(51) Int. Cl. B60W 40/072; B60W 30/10; G06V 20/56

(52) U.S. Cl. CPC B60W 40/072; B60W 30/10; G06V 20/588; B60W 2520/10; B60W 2552/30

(57) ABSTRACT

Disclosed is a device for controlling travel. The device includes a sensor, a memory, and a controller. For example, the device may obtain, via a sensor (e.g., a LIDAR), a line recognition result associated with a road on which a vehicle is traveling, determine, based on the line recognition result, whether information, which comprises at least one of a curvature of the road or a curvature change rate of the road, satisfies a specified condition, and, based on the information satisfying the specified condition, generate calibrated line information using an expected curvature change rate, wherein the expected curvature change rate is determined based on: the curvature change rate, and at least one of an expected heading angle of the vehicle at a target point on the road, an expected curvature at the target point, or an expected lateral error at the target point.

### CROSS-REFERENCE TO RELATED APPLICATION

This application claims the benefit of priority to Korean Patent Application No. 10-2023-0099888, filed in the Korean Intellectual Property Office on Jul. 31, 2023, the entire contents of which are incorporated herein by reference.

### TECHNICAL FIELD

The present disclosure relates to a device and a method for controlling movement of a vehicle, and more specifically, to compensating for uneven performance in line recognition.

### BACKGROUND

A travel control device may execute host vehicle control algorithms and may be categorized into partial automation, conditional automation, high automation, and/or full automation depending on the level of automated control thereof.

For example, the travel control device (also referred to as an autonomous driving control device) may recognize information (e.g., a traffic line) of a road on which the host vehicle is traveling by using a sensor. For example, the travel control device may identify line recognition results using a component (e.g., a front camera) of the sensor disposed in one area of the host vehicle, and perform the travel control (or autonomous driving control) of the host vehicle based on the results.

For example, the travel control device may identify a polynomial of a specified degree (e.g., a third-degree polynomial) corresponding to the line (e.g., a traffic line) based on the information of the road identified using the sensor or travel information of the host vehicle, or any combination thereof.

However, the travel control device may have instances in which accuracy momentarily decreases in a process of deriving results corresponding to the line based on the above-described line recognition algorithm. For example, a peak phenomenon may occur when at least some of coefficients of the polynomial corresponding to the line momentarily increase or decrease.

Additionally, because a travel environment in which the host vehicle is traveling may not be uniform, there may be inaccuracy in recognition results, such as line shaking occurring when the travel environment changes or when the host vehicle travels under a specific travel environment.

Furthermore, because of the effective measuring range of the sensor, a situation may occur where the line recognition may be inaccurate or impossible.

### SUMMARY

The present disclosure has been made to solve the above-mentioned problems occurring in some embodiments while advantages achieved by those embodiments are maintained intact.

An aspect of the present disclosure may selectively provide a compensation algorithm depending on whether information on at least one of a curvature of a road identified using a sensor or a curvature change rate, or any combination thereof satisfies a specified condition.

Another aspect of the present disclosure may provide a travel control device that determines that a peak phenomenon has occurred when a change amount of a curvature change rate and a change amount of a curvature have opposite signs and the change amount of the curvature is identified as being equal to or greater than a critical value.

Another aspect of the present disclosure may provide a travel control device that performs travel control by compensating for line recognition results during a specified time duration (e.g., 2 seconds), and continues to use the line recognition results identified using a sensor after the specified time duration has elapsed.

Another aspect of the present disclosure may provide a travel control device that selects, among at least one target point candidate, a target point that generates corrected line information such that a difference between a corrected curvature and a reference curvature has a small value as a target point for a compensation algorithm.

Another aspect of the present disclosure may provide a travel control device that efficiently sets at least one value among coefficients corresponding to a line using at least one weight.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a device may include: a sensor; memory storing instructions; and a controller operatively connected to the sensor and the memory. The instructions, when executed by the controller, may cause the device to: obtain, via the sensor, a line recognition result associated with a road on which a vehicle is traveling; determine, based on the line recognition result, whether information, which includes at least one of a curvature of the road or a curvature change rate of the road, satisfies a specified condition; and based on the information satisfying the specified condition, generate calibrated line information using an expected curvature change rate. The expected curvature change rate may be determined based on: the curvature change rate, and at least one of an expected heading angle of the vehicle at a target point on the road, an expected curvature at the target point, or an expected lateral error at the target point.

The specified condition may include: a first condition including one of: an increase in the curvature change rate and a decrease in the curvature, or a decrease in the curvature change rate and an increase in the curvature, and a second condition including the curvature changing by more than a threshold value.

The instructions, when executed by the controller, may further cause the device to: control, during a time duration after a time associated with the information, movement of the vehicle based on the line recognition result and the calibrated line information.

The instructions, when executed by the controller, may further cause the device to: determine at least one target point candidate that the vehicle is expected to reach within a time duration after a time associated with the information; and determine the expected curvature change rate at the target point. The target point may be one of the at least one target point candidate.

The instructions, when executed by the controller, may further cause the device to: determine, among curvatures included in the line recognition result, a reference curvature associated with a second time before the time associated with the information; and determine, among the at least one target point candidate, the target point such that a difference between a calibrated curvature at a time point when the specified condition is satisfied and the reference curvature is smallest.

The instructions, when executed by the controller, may further cause the device to: determine, based on curvature change rates included in the line recognition result, a first curvature change rate at a time associated with the information; and determine, based on the curvature change rates included in the line recognition result, a second curvature change rate representing an overall curvature change rate of the road; determine, based on at least one of the first curvature change rate, the second curvature change rate, or a weight of each of the first curvature change rate and the second curvature change rate, the expected curvature change rate for a time duration starting at the time associated with the information.

The weight of each of the first curvature change rate and the second curvature change rate may include a first weight of the first curvature change rate. The first weight may decrease during the time duration.

The instructions, when executed by the controller, may further cause the device to: determine, via the sensor, a travel speed of the vehicle; and determine the target point based on at least one of the travel speed or a predetermined time duration.

According to one or more example embodiments of the present disclosure, a method may include: obtaining, by a controller and via a sensor, a line recognition result associated with a road on which a vehicle is traveling; determining, by the controller and based on the line recognition result, whether information, which includes at least one of a curvature of the road or a curvature change rate of the road, satisfies a specified condition; and based on the information satisfying the specified condition, generating, by the controller, calibrated line information using an expected curvature change rate. The expected curvature change rate may be determined based on: the curvature change rate, and at least one of an expected heading angle of the vehicle at a target point on the road, an expected curvature at the target point, or an expected lateral error at the target point.

The specified condition may include: a first condition including one of: an increase in the curvature change rate and a decrease in the curvature, or a decrease in the curvature change rate and an increase in the curvature, and a second condition including the curvature changing by more than a threshold value.

The method may further include: controlling, by the controller and during a time duration after a time associated with the information, movement of the vehicle based on the line recognition result and the calibrated line information.

The method may further include: determining, by the controller, at least one target point candidate that the vehicle is expected to reach within a time duration after a time associated with the information; and determining, by the controller, the expected curvature change rate at the target point. The target point may be one of the at least one target point candidate.

The method may further include: determining, by the controller and among curvatures included in the line recognition result, a reference curvature associated with a second time before the time associated with the information; and determining, by the controller and among the at least one target point candidate, the target point such that a difference between a calibrated curvature at a time point when the specified condition is satisfied and the reference curvature is smallest.

The method may further include: determining, by the controller and based on curvature change rates included in the line recognition result, a first curvature change rate at a time associated with the information; and determining, based on the curvature change rates included in the line recognition result, a second curvature change rate representing an overall curvature change rate of the road; determining, by the controller and based on at least one of the first curvature change rate, the second curvature change rate, or a weight of each of the first curvature change rate and the second curvature change rate, the expected curvature change rate for a time duration starting at the time associated with the information.

The weight of each of the first curvature change rate and the second curvature change rate may include a first weight of the first curvature change rate. The first weight may decrease during the time duration.

According to one or more example embodiments of the present disclosure, a computer-readable medium storing instructions that, when executed, may cause: obtaining, by a controller and via a sensor, a line recognition result associated with a road on which a vehicle is traveling; determining, by the controller and based on the line recognition result, whether information, which includes least one of a curvature of the road or a curvature change rate of the road, satisfies a specified condition; and based on the information satisfying the specified condition, generating, by the controller, calibrated line information using an expected curvature change rate. The expected curvature change rate may be determined based on: the curvature change rate, and at least one of an expected heading angle of the vehicle at a target point on the road, an expected curvature at the target point, or an expected lateral error at the target point.

The specified condition may include: a first condition including one of: an increase in the curvature change rate and a decrease in the curvature, or a decrease in the curvature change rate and an increase in the curvature, and a second condition including the curvature changing by more than a threshold value.

The instructions, when executed, may further cause: controlling, by the controller and during a time duration after a time associated with the information, movement of the vehicle based on the line recognition result and the calibrated line information.

The instructions, when executed, may further cause: determining, by the controller, at least one target point candidate that the vehicle is expected to reach within a time duration after a time associated with the information; and determining, by the controller, the expected curvature change rate at the target point. The target point may be one of the at least one target point candidate.

The instructions, when executed, may further cause: determining, by the controller and among curvatures included in the line recognition result, a reference curvature associated with a second time before the time associated with the information; and determining, by the controller and among the at least one target point candidate, the target point such that a difference between a calibrated curvature at a time point when the specified condition is satisfied and the reference curvature is smallest.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing components of a travel control device;

FIG. 2 is a conceptual diagram showing results of line recognition performed by a travel control device;

FIG. 3 illustrates conceptual diagrams showing results of line recognition performed by a travel control device;

FIG. 4 illustrates conceptual diagrams showing results of line recognition performed by a travel control device;

FIG. 5 illustrates conceptual diagrams showing results of line recognition performed by a travel control device;

FIG. 6 is a conceptual diagram of operation of a travel control device;

FIG. 7 is a graph showing a change over time in a parameter used by a travel control device;

FIG. 8 illustrates conceptual diagrams of operation of a travel control device;

FIG. 9 illustrates conceptual diagrams of operation of a travel control device;

FIG. 10 illustrates conceptual diagrams of operation of a travel control device;

FIG. 11 is a flowchart of a travel control method; and

FIG. 12 illustrates a computing system related to a travel control method.

In relation to the description of the drawings, the same or similar reference numerals may be used for the same or similar components.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component: is designated by the identical numeral even when they are displayed on other drawings. Further, in describing the one or more example embodiment of the present disclosure, a detailed description of the related known configuration or function will be omitted when it is determined that it interferes with the understanding of the example embodiment of the present disclosure.

In describing the components of the one or more example embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

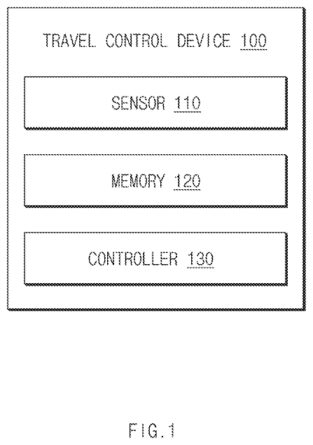

Hereinafter, one or more example embodiments of the present disclosure will be described in detail with reference to FIGS. 1 to 12.

FIG. 1 is a block diagram showing components of a travel control device.

A travel control device 100 may include at least one of a sensor 110, a memory 120, or a controller 130, or any combination thereof. A configuration of the travel control device 100 shown in FIG. 1 is illustrative, and the present disclosure is not limited thereto. For example, the travel control device 100 may further include components not shown in FIG. 1 (e.g., at least one of an interface, a communication device, a display, or a notification device, or any combination thereof).

The sensor 110 may acquire (or sense) various information used regarding travel of a vehicle (e.g., a host vehicle).

For example, the sensor 110 may include at least one sensor including at least one of a camera, a radar, or a LiDAR, or any combination thereof. As an example, the sensor 110 may include a front camera that identifies information on an area in front of the host vehicle.

For example, the sensor 110 may identify information on at least one of a travel state of the host vehicle, a travel mode, a road, or an area adjacent to the host vehicle, or any combination thereof.

As an example, the sensor 110 may identify information on the travel state of the host vehicle including at least one of an actual (or real-time) travel speed, a travel direction, an acceleration, and/or a deceleration of the host vehicle, or any combination thereof.

As an example, the sensor 110 may identify the information on the road on which the host vehicle is traveling. For example, the controller 130 may identify line recognition results related to the road based on at least some of the information acquired using the sensor 110. The line recognition results may include, for example, information (e.g., a polynomial) on a virtual line corresponding to the road.

At least some of the operations described above as being performed by the sensor 110 may be understood as being performed by the controller 130 using the information acquired by the sensor 110.

The memory 120 may store instructions or data. For example, the memory 120 may store one or more instructions that allow the travel control device 100 to perform various operations when executed by the controller 130.

For example, the memory 120 may be implemented as one chipset with the controller 130. The controller 130 may include at least one of a communication processor or a modem.

For example, the memory 120 may store various information related to the travel control device 100. As an example, the memory 120 may store information on an operation history of the controller 130. As an example, the memory 120 may store information related to states and/or operation of components of the host vehicle (e.g., at least one of an engine control unit (ECU), the sensor 110, or the controller 130, or any combination thereof).

The controller 130 may be operatively connected to the sensor 110 and/or the memory 120. For example, the controller 130 may control the operation of the sensor 110 and/or the memory 120.

For example, the controller 130 may identify the line recognition results related to the road on which the host vehicle is traveling using the sensor 110. For example, the controller 130 may identify the line recognition results including a formula representing the road, using at least some of the information acquired using the sensor 110.

As an example, the line recognition results may include information on Formula 1 below corresponding to a line of the road.

$$y = {ax}^{3} + {bx}^{2} + cx + d \qquad [ Formula 1 ]$$

For example, a y value may be a lateral error between the identified host vehicle and the line of the road based on an x value corresponding to a real-time location of the host vehicle.

For example, the controller 130 may identify information on a travel situation based on the real-time location of the host vehicle, based on Formula 2 below.

$${y}_{0} ( x ) = {a}_{0} {x}^{2} + {b}_{0} {x}^{2} + {c}_{0} x + {d}_{0} \qquad [ Formula 2 ]$$

$${\dot{y}}_{0} ( x ) = 3 {a}_{0} {x}^{2} + 2 {b}_{0} x + {c}_{0}$$

$${\ddot{y}}_{0} = 6 {a}_{0} x + 2 {b}_{0}$$

$${{y}^{...}}_{0} ( x ) = 6 {a}_{0}$$

For example, y₀(x), [symbol] (x), [symbol] (x), [symbol] (x) may be formulas respectively representing the lateral error between the host vehicle and the line of the road, a heading error, a curvature of the road (or the line), and a curvature change rate of the road that are identified based on the x value corresponding to the real-time location of the host vehicle.

For example, the controller 130 may identify a heading angle of the host vehicle, the curvature of the road, and/or the curvature change rate as coefficients of Formula 2 based on a case where the x value is 0.

As an example, when the x value is 0, the curvature change rate \dot{ρ} of the road may be 6a.

As an example, when the x value is 0, the curvature ρ of the road may be 2b.

As an example, when the x value is 0, the heading error θ_{H} of the host vehicle may be c.

As an example, when the x value is 0, the lateral error ep of the host vehicle may be d.

For example, the controller 130 may identify a target point corresponding to a control target point, and perform travel control in a scheme of reducing a lateral error and/or a heading error of the host vehicle at the identified target point.

As an example, the controller 130 may use the sensor 110 to identify the real-time travel speed of the host vehicle, and identify the target point using at least one of the real-time travel speed or a preset time (or a look ahead time (e.g., 0.6 seconds)), or any combination thereof. The preset time may be, for example, a setting value that may be changed by a user. The controller 130 may identify a target point xₜₚ via multiplication of a real-time travel speed vₓ of the host vehicle and a preset time tₐₕ.

The controller 130 may identify a formula based on Formula 3 below by substituting a target point xₜₚ into Formula 2 above, and identify new line information to replace at least a partial section of the existing line recognition results based on the identified formula.

$${y}_{0} ( {x}_{tp} ) = {a}_{1} {x}_{tp}^{3} + {b}_{1} {x}_{tp}^{2} + {c}_{1} {x}_{tp} + {d}_{1} \qquad [ Formula 3 ]$$

$${\dot{y}}_{0} ( {x}_{tp} ) = 3 {a}_{1} {x}_{tp}^{2} + 2 {b}_{1} {x}_{tp} + {c}_{1}$$

$${\ddot{y}}_{0} ( {x}_{tp} ) = 6 {a}_{1} {x}_{tp} + 2 {b}_{1}$$

$${{y}^{...}}_{0} = 6 {a}_{1}$$

For example, the controller 130 may determine whether information on at least one of the curvature or the curvature change rate of the road, or any combination thereof included in the line recognition results satisfies a specified condition.

As an example, the specified condition may include a first condition in which the curvature change rate increases and the curvature decreases, or the curvature change rate decreases and the curvature increases. In other words, the controller 130 may determine that the first condition is satisfied when there is a section in which the curvature change rate increases and the curvature decreases, or the curvature change rate decreases and the curvature increases in result data of acquiring the information on the road using the sensor 110. That is, the controller 130 may determine that the first condition is satisfied when there is a section in which change amounts of the curvature change rate and the curvature have opposite signs.

As an example, the specified condition may include a second condition in which the curvature changes by a value equal to or greater than a critical value. In other words, the controller 130 may determine that the second condition is satisfied when there is a section in which the curvature momentarily changes by the value equal to or greater than the predefined critical value in the result data of acquiring the information on the road using the sensor 110.

For example, when both the above-described first condition and second condition are satisfied, the controller 130 may determine that the information on at least one of the curvature or the curvature change rate of the road, or any combination thereof included in the line recognition results satisfies the specified condition.

For example, when the information satisfies the specified condition (e.g., the first condition and/or the second condition), the controller 130 may generate calibrated (e.g., corrected) line information using target information including an expected curvature change rate identified using at least one of an expected heading angle of the host vehicle, an expected curvature, or an expected lateral error at the target point on the road, or any combination thereof and the curvature change rate.

As an example, the calibrated (e.g., corrected) line information may include information that corrects at least some of the initially identified line recognition results within a specified time duration range to generate new line recognition compensated from the initially identified line results recognition results, and allows a partial section of the initially identified line recognition results to be replaced with the new line recognition results.

As an example, the controller 130 may control the travel of the host vehicle based on the line recognition results compensated for based on the line information calibrated (e.g., corrected) within a specified time duration (e.g., 2 seconds) from a time point at which the information satisfies the specified condition.

As an example, the controller 130 may identify at least one target point candidate that the host vehicle is expected to reach within a specified time duration range (e.g., 0.2 seconds before and 0.2 seconds after a time point at which 0.6 seconds has elapsed) after a preset time duration (e.g., 0.6 seconds) from the time point at which the information satisfies the specified condition. For example, the controller 130 may identify the at least one target point candidate including at least one of a target point corresponding to a time point after 0.4 seconds, a target point corresponding to a time point after 0.6 seconds, or a target point corresponding to a time point after 0.8 seconds, from the time point at which the information satisfies the specified condition, or any combination thereof.

As an example, the controller 130 may identify target information at one target point among the at least one target point candidate. For example, the controller 130 may identify, among the curvatures included in the line recognition results, a reference curvature at a second time point that is a time point immediately before a first time point (or the first time point) at which the information satisfies the specified condition, and then select, among the at least one target candidate, a target point that generates the calibrated (e.g., corrected) line information such that a difference between a corrected curvature at the time point at which the specified condition is satisfied and the reference curvature is the smallest. In other words, the controller 130 may select the target point that generates the calibrated line information such that curvatures immediately before and after a peak phenomenon occurs are connected to each other in a continuous manner.

The controller 130 may identify a lateral error and a heading error of the host vehicle, the curvature, and the curvature change rate at the target point xₜₚ based on Formula 3 above.

For example, polynomial coefficients of Formula 3 may be different from the polynomial coefficients of Formula 2. The controller 130 may acquire new line information by identifying the polynomial coefficients of Formula 3 via simultaneous equation operation, and identify a new line section that replaces at least a partial section of a line section included in the existing line recognition results based on the new line information.

$${a}_{1} ( k ) = {a}_{0} ( k - 1 ) \qquad [ Formula 4 ]$$

Referring to Formula 4, if the peak phenomenon occurs at a ‘k’ time point, the controller 130 may set an a₁(k) value for generating the new line information to an a₀(k−1) value and then perform the simultaneous equation operation based on the polynomials of Formula 3. The above value set by the controller 130 may be defined as a_{HOLD}.

$${a}_{1} = {a}_{Hold} \qquad [ Formula 5 ]$$

$${b}_{1} = [ {\ddot{y}}_{0} ( {x}_{tp} ) - 6 {a}_{1} {x}_{tp} ] / 2$$

$${c}_{1} = {\dot{y}}_{0} ( {x}_{tp} ) - ( 3 {a}_{1} {x}_{tp}^{2} + 2 {b}_{1} {x}_{tp} )$$

$${d}_{1} = {y}_{0} ( {x}_{tp} ) - ( {a}_{1} {x}_{tp}^{3} + {b}_{1} {x}_{tp}^{2} + {c}_{1} {x}_{tp} )$$

With reference to Formula 5, the controller 130 may identify b₁, c₁, and d₁. For example, according to Formula 5, the controller 130 may identify the three unknowns b₁, c₁, and d₁ based on four equations.

$${a}_{1} ( k ) = α {a}_{Hold} + ( 1 - α ) {a}_{0} ( k ) \qquad [ Formula 6 ]$$

Referring to Formula 6, the controller 130 may identify the first curvature change rate coefficient a_{HOLD} at the time point at which the information satisfies the specified condition and a second curvature change rate coefficient a₀(k) included in the line recognition results among the curvature change rates included in the line recognition results. A first curvature change rate and a second curvature change rate, which will be described below, may mean coefficients of a polynomial corresponding to the curvature change rate.

As an example, the first curvature change rate may correspond to a curvature change rate coefficient at a time point at which the peak phenomenon has occurred. In other words, the first curvature change rate may be a curvature change rate identified by the sensor 110 immediately before the peak phenomenon occurs (or at the time point at which the peak phenomenon has occurred).

As an example, the second curvature change rate may be a curvature change rate coefficient identified by the sensor 110 for the entire road, including the first curvature change rate. In other words, the first curvature change rate may be a fixed value (or a constant), and the second curvature change rate may be a variable that varies over time.

For example, the controller 130 may identify an expected curvature change rate during the specified time duration (e.g., 2 seconds) from the time point at which the information satisfies the specified condition, using at least one of the first curvature change rate, the second curvature change rate, or a weight of each of the first curvature change rate and the second curvature change rate, or any combination thereof.

As an example, the controller 130 may identify a first weight ‘α’ corresponding to the first curvature change rate and a second weight (1−α) corresponding to the second curvature change rate. For example, the controller 130 may set the first weight ‘α’ corresponding to the first curvature change rate to gradually decrease for the specified time duration (e.g., 2 seconds) from the time point at which the information satisfies the specified condition.

As an example, the controller 130 may identify the first weight ‘α’ using Formula 7 below.

$$α ( k ) = \frac{{t}_{Deact} - {t}_{k}}{{t}_{Deact} - {t}_{Act}} \qquad [ Formula 7 ]$$

For example, t_{Act} may be a time point at which the existing line information begins to be replaced based on the new line information (or a time point at which activation of line correction logic begins). For example, t_{Deact} may be a time point at which the operation of replacing the existing line information based on the new line information ends (or a time point at which the activation of the line correction logic ends). For example, tₖ may be the ‘k’ time point. For example, a time duration from t_{Act} to t_{Deact} may be a total of 2 seconds, but this is an example, and the present disclosure is not limited thereto.

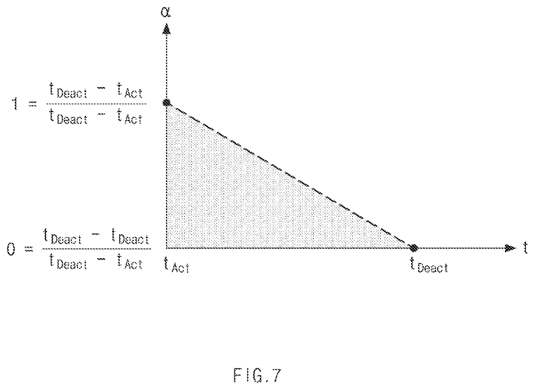

An example in which the controller 130 identifies α(k) may be described in detail in a description of FIG. 7 below.

For example, the controller 130 may select, using a value of Formula 8 below, one target point to be used when identifying new line results among the at least one target point candidate.

$$Δ {b}_{tp} = \vert {b}_{1 , {t}_{tp}} ( k ) - {b}_{0} ( k - 1 ) \vert \qquad [ Formula 8 ]$$

Referring to Formula 8, the controller 130 may identify, among the at least one target point candidate, a target point that generates the calibrated (e.g., corrected) line information such that the difference between the calibrated curvature at the time point at which the specified condition is satisfied and the reference curvature is the smallest, and identify a target time point tₜₚ corresponding to the identified target point.

For example, the controller 130 may identify, as the target point to be used to generate the calibrated line information, a target point where a difference Δbₜₚ between a first calibrated curvature coefficient b_{1,tp}(k) corresponding to the curvature calibrated based on the target point at the target time point tₜₚ, and a reference curvature coefficient b₀(k−1) corresponding to the curvature initially acquired using the sensor 110 is the smallest.

For example, the controller 130 may use Formula 9 below to determine whether at least some (e.g., at least one of the curvature or the curvature change rate, or any combination thereof) of the information of the line recognition results acquired using the sensor 110 satisfy the specified condition.

$$[ {b}_{0} ( k ) - {b}_{0} ( k - 1 ) ] > {b}_{Th} \qquad [ Formula 9 ]$$

$$[ {a}_{0} ( k ) - {a}_{0} ( k - 1 ) ] \times [ {b}_{0} ( k ) - {b}_{0} ( k - 1 ) ] < 0$$

Referring to Formula 9, the controller 130 may identify a coefficient b₀ related to the curvature and a coefficient a₀ related to the curvature change rate among the information of the line recognition results initially acquired using the sensor 110.

For example, a sign of a value obtained by multiplying a difference between the coefficient a₀(k) related to a curvature change rate at the ‘k’ time point and the coefficient a₀(k−1) related to a curvature change rate at a k−1 time point, and a difference between a coefficient b₀(k) related to a curvature at the ‘k’ time point and the coefficient b₀(k−1) related to a curvature at the k−1 time point may be identified. For example, when the value obtained by multiplying the differences is a negative number, the controller 130 may determine that the first condition in which the curvature change rate needs to be increased and the curvature needs to be decreased, or the curvature change rate needs to be decreased and the curvature needs to be increased is satisfied.

For example, when the difference between the coefficient b₀(k) related to the curvature at the ‘k’ time point and the coefficient b₀(k−1) related to the curvature at the k−1 time point, which is a time point immediately before the ‘k’ time point, exceeds a critical coefficient b_{TH}, the controller 130 may determine that the second condition in which the curvature needs to change by the value equal to or greater than the critical value is satisfied.

The components of the travel control device 100 shown in FIG. 1 are illustrative, and the present disclosure is not limited thereto. For example, the travel control device 100 may further include the display (not shown) and/or the notification device (not shown).

The display may visually provide a user interface containing a travel path (e.g., a biased travel path) of the host vehicle to the user.

For example, the display may provide the user interface containing information on at least one of the line information generated by the controller 130 via the information initially acquired using the sensor 110 or the line information newly generated for at least the partial section of the line based on a correction algorithm, or any of these to the user in real time.

The notification device may include at least one output device. For example, the notification device may include the output device (e.g., a speaker) included in at least a portion of the interior of the host vehicle.

For example, the notification device may output various types of sounds to the outside.

As an example, the notification device may provide the user with a guidance message indicating that at least the partial section of the line displayed in real time under the control of the controller 130 is displayed via the correction algorithm.

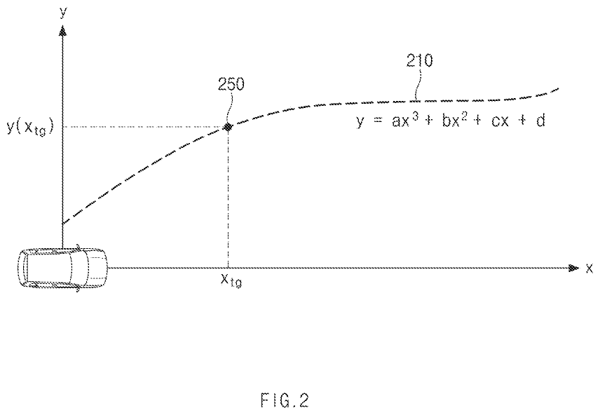

FIG. 2 is a conceptual diagram showing results of line recognition performed by a travel control device.

A travel control device (e.g., the travel control device 100 in FIG. 1) may generate results (e.g., the third-degree polynomial) representing a road on which a host vehicle is traveling based on at least some of information acquired using a sensor (e.g., the sensor 110 in FIG. 1).

Referring to reference numeral 210, the travel control device may identify the third-degree polynomial corresponding to the road (or the line). The third-degree polynomial may be a formula corresponding to Formula 1 described above.

Referring to reference numeral 250, the travel control device may identify a lateral error y(x_{tg}) with the line of the host vehicle at the target point x_{tg} by inputting the target point x_{tg} into a domain of the third-degree polynomial.

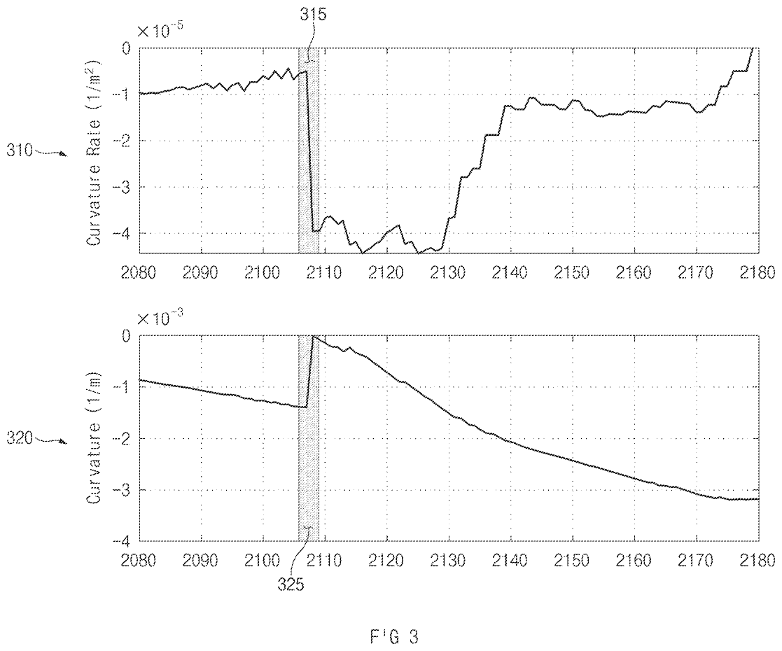

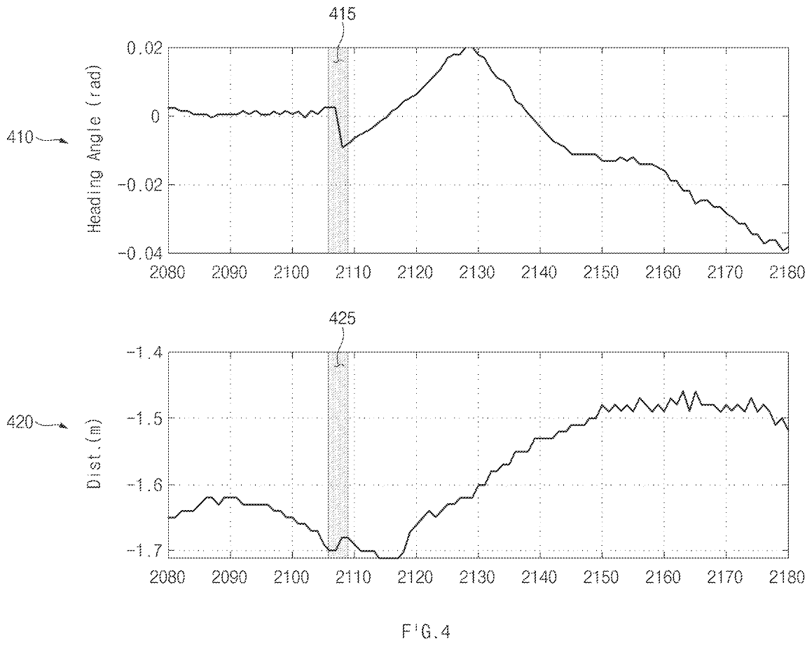

FIGS. 3 and 4 illustrate conceptual diagrams showing results of line recognition performed by a travel control device.

A travel control device (e.g., the travel control device 100 in FIG. 1) may identify a curvature change rate of a road on which a host vehicle is traveling, a curvature, a heading angle (or a heading error), and/or a lateral error using a sensor (e.g., the sensor 110 in FIG. 1).

In graphs of reference numerals 310, 320, 410, and 420, peak sections that occur during a process in which the travel control device performs line recognition are shown.

Referring to reference numeral 310 in FIG. 3, the travel control device may identify the curvature change rate of the road in real time.

For example, it may be seen that, in a period between 2100 ms and 2110 ms, a first peak section 315 in which the curvature change rate acquired by the travel control device using the sensor momentarily decreases has occurred.

Referring to reference numeral 320 in FIG. 3, the travel control device may identify the curvature change rate of the road in real time.

For example, it may be seen that, in a period between 2100 ms and 2110 ms, a second peak section 325 in which the curvature acquired by the travel control device using the sensor momentarily increases has occurred.

Referring to reference numeral 410 in FIG. 4, the travel control device may identify the heading angle (or the heading error) of the host vehicle on the road in real time.

For example, it may be seen that, in a period between 2100 ms and 2110 ms, a third peak section 415 in which the heading angle acquired by the travel control device using the sensor momentarily decreases has occurred.

Referring to reference numeral 420 in FIG. 4, the travel control device may identify the lateral error with the line of the host vehicle on the road in real time.

For example, it may be seen that, in a period between 2100 ms and 2110 ms, a fourth peak section 425 in which the lateral error acquired by the travel control device using the sensor momentarily decreases has occurred.

There is a problem that line recognition accuracy of the travel control device is reduced because of at least some of the above-described peak sections.

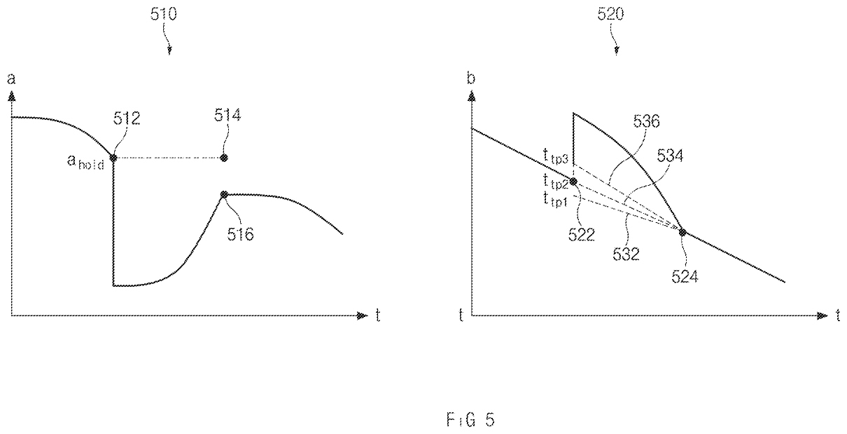

FIG. 5 illustrates conceptual diagrams showing results of line recognition performed by a travel control device.

A travel control device (e.g., the travel control device 100 in FIG. 1) may identify changes of a value ‘a’ corresponding to a curvature change rate (or a curvature change rate coefficient) and a value ‘b’ corresponding to a curvature over time (or a curvature coefficient).

Referring to reference numeral 510, the travel control device may set a value ‘a’ at a first time point 512 at which information acquired using a sensor (e.g., the sensor 110 in FIG. 1) satisfies a specified condition to the a_{HOLD} value. Alternatively, the travel control device may set a value ‘a’ at a time point immediately before the first time point 512 to the a_{HOLD} value. In this regard, when new line information is generated by fixing the value ‘a’ to the a_{HOLD} value, it may be difficult to generate appropriate line information because an error between a final value ‘a’ 514 at an end time point 516 at which a correction algorithm ends as a specified time duration (e.g., 2 seconds) has elapsed from the first time point 512, and an existing value ‘a’ of line information acquired using the sensor is relatively great.

To prevent such gap, the travel control device may identify the curvature change rate (or the curvature change rate coefficient) to be used to generate the new line information based on Formula 6 above. Accordingly, the travel control device may secure continuity between the existing line information and the new line information in the process of generating the new line information.

Referring to reference numeral 520, the travel control device may identify target point candidates that a host vehicle is expected to reach within a specified time duration range (e.g., a period between a time point 0.4 seconds after and a time point 0.8 seconds after a first time point 522) after a preset time duration (e.g., 0.6 seconds) from the first time point 522 at which the information acquired using the sensor satisfies the specified condition.

For example, the travel control device may identify at least one of a first target time point tₜₚ₁ corresponding to a first target point (e.g., a time point 0.4 seconds after the first time point 522), second target time point tₜₚ₂ corresponding to a second target point (e.g., a time point 0.6 seconds after the first time point 522), or a third target time point tₜₚ₃ corresponding to a third target point (e.g., a time point 0.8 seconds after the first time point 522), or any combination thereof.

For example, the travel control device may identify a difference between a curvature calibrated at the first time point 522 based on each of the at least one target point candidate and a reference curvature at the first time point 522 acquired in advance using the sensor. As an example, the travel control device may identify first curvature information 532 newly generated based on the first target point, second curvature information 534 newly generated based on the second target point, and third curvature information 536 newly generated based on the third target point during a period from the first time point 522 to a second time point 524 (e.g., a time point at which the correction algorithm ends), respectively.

For example, based on a graph according to reference numeral 520, the travel control device may identify that a curvature calibrated based on the second target point corresponding to the second target time point tₜₚ₂ has the smallest difference from the reference curvature, and determine the calibrated line information to be generated based on the second target point.

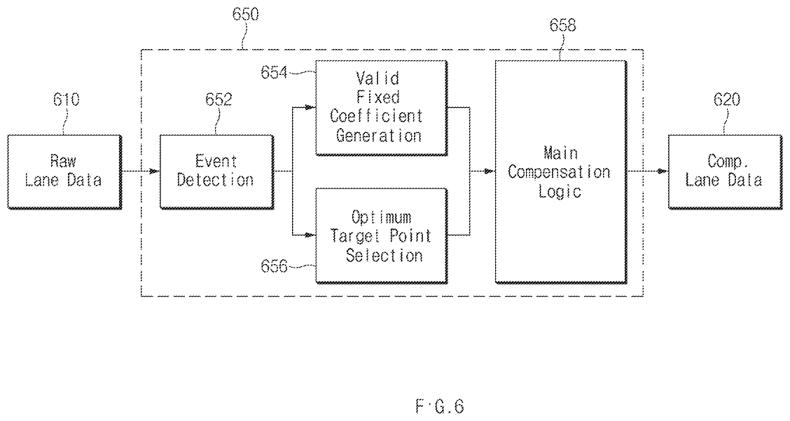

FIG. 6 is a conceptual diagram of operation of a travel control device.

Referring to reference numeral 610, a travel control device (e.g., the travel control device 100 in FIG. 1) may identify raw data related to the road using a sensor (e.g., the sensor 110 in FIG. 1). For example, the raw data may include at least one of a curvature change rate or a curvature of a road, or any combination thereof.

According to reference numeral 650, the travel control device may generate new line information corresponding to a certain section of the road via a correction algorithm when at least some of the raw data satisfy a specified condition.

For example, according to reference numeral 652, the travel control device may sense an event in which the raw data satisfies the specified condition.

As an example, the specified condition may include a first condition in which the curvature change rate increases and the curvature decreases, or the curvature change rate decreases and curvature increases, and a second condition in which the curvature changes by a value equal to or greater than a critical value.

For example, according to reference numeral 654, the travel control device may identify values of at least some of coefficients of a polynomial corresponding to the road. As an example, the travel control device may identify a coefficient corresponding to each of at least one of the curvature change rate, the curvature, a heading error or a lateral error of a host vehicle, or any combination thereof.

For example, according to reference numeral 656, the travel control device may select the target point. A description related to the travel control device that selects a target point may be replaced with the description of FIG. 1 above.

For example, according to reference numeral 658, the travel control device may execute a main compensation (e.g., calibration) logic. As an example, the travel control device may correct at least a portion of a line generated based on the existing raw data, based on the at least one newly identified coefficient and the target point.

According to reference numeral 620, the travel control device may compensate for at least partial section of the line that was generated based on the raw data, based on at least some of the new line information generated based on the correction algorithm according to reference numeral 650. The travel control device may identify at least the partial section of the line based on the compensated line recognition results.

FIG. 7 is a graph showing a change over time in a parameter used by a travel control device.

Referring to FIG. 7, a travel control device (e.g., the travel control device 100 in FIG. 1) may identify an expected curvature change rate for at least a partial section of a road on which a host vehicle is traveling based on at least some of line recognition results acquired using a sensor (e.g., the sensor 110 in FIG. 1).

For example, the travel control device may identify a first curvature change rate at the first time point t_{Act} (e. g., the time point at which the peak phenomenon has occurred) at which information acquired using the sensor satisfies a specified condition and a curvature change rate of the entire road included in the line recognition results among the curvature change rates included in the line recognition results.

As an example, based on a first curvature change rate and a curvature change rate of the entire road, the travel control device may identify a first coefficient (e.g., the a_{HOLD}) corresponding to the first curvature change rate and a coefficient (e.g., the a₀(k)) corresponding to the curvature change rate of the entire road.

The first coefficient may be, for example, a coefficient corresponding to a curvature change rate at one point of the road that the host vehicle is expected to reach at the first time point t_{Act} at which the peak phenomenon has occurred (or a time point immediately before the peak phenomenon occurs).

The coefficient corresponding to the curvature change rate of the entire road may be, for example, a coefficient corresponding to a curvature change rate at one point of the road that the host vehicle is expected to reach at a ‘k’ time point. The ‘k’ time point may be, for example, one time point between the first time point t_{Act} and the second time point t_{Deact}.

For example, the travel control device may identify an expected curvature change rate at the second time point t Deact, which is after a specified time duration (e.g., 2 seconds) from the first time point t_{Act} at which the peak phenomenon has occurred, using at least one of the first curvature change rate, the second curvature change rate, or a weight of each of the first curvature change rate and the second curvature change rate, or any combination thereof.

As an example, the travel control device may set the first weight α(k) corresponding to the first curvature change rate based on a graph shown in FIG. 7. For example, the travel control device may identify the first weight α(k) based on the formula according to Formula 7 described above.

As an example, the first weight α(k) may be 1 at the first time point t_{Act} (or a time point at which ‘k’ is t_{Act}).

As an example, the travel control device may set the first weight α(k) to gradually decrease during a specified time duration (e.g., a time duration to the second time point t Deact) from the first time point t_{Act}.

As an example, the first weight α(k) may be 0 at the second time point t_{Deact} (or the time point at which ‘k’ is t_{Deact}).

The travel control device may operate a compensation (e.g., calibration) algorithm such that compensation (e.g., calibration) for the peak phenomenon is achieved by a relatively great amount by setting the first weight α(k) to the a_{HOLD}, which is the fixed value, at the first time point t_{Act} at which the accuracy decreases by a relatively great amount as the peak phenomenon begins to occur.

The travel control device may use information related to the curvature change rate that reflects a ratio of a₀(k) corresponding to the information initially identified by the sensor in a gradually increasing manner from the first time point t_{Act} at which the peak phenomenon has occurred, and is identified by naturally converging to the a₀(k) value without using the a_{HOLD} value in the line recognition at the second time t_{Deact} at which the compensation algorithm is finally deactivated. Accordingly, the travel control device may continuously secure the line recognition results for the travel control.

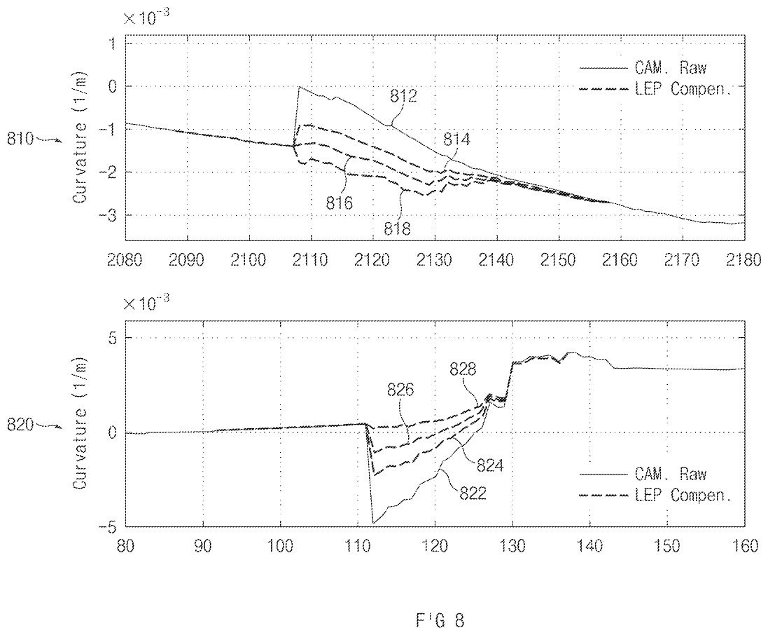

FIG. 8 illustrates conceptual diagrams of operation of a travel control device.

A travel control device (e.g., the travel control device 100 in FIG. 1) may acquire various information initially used for line recognition using a sensor (e.g., the sensor 110 in FIG. 1). The travel control device may determine whether at least some (e.g., a curvature and a curvature change rate) of the acquired information satisfy a specified condition, and, when the specified condition is satisfied, generate new line information for a partial section of a line via a compensation algorithm.

Referring to reference numeral 810, the travel control device may acquire information related to a curvature according to reference numeral 812 using the sensor.

For example, it may be seen that, in a section between 2100 ms and 2110 ms, a first peak section (e.g., the first peak section 315 in FIG. 3) in which the curvature acquired by the travel control device using the sensor momentarily increases has occurred.

For example, the travel control device may identify at least one target candidate to apply the compensation algorithm for a peak phenomenon. As the at least one target candidate, at least one target point candidate that the host vehicle is expected to reach within a specified time duration range (e.g., a time duration range from a time point 0.4 seconds after to 0.8 seconds after a first time point) after a preset time duration (e.g., 0.4 seconds) from the first time point at which the peak phenomenon has occurred may be identified.

For example, the travel control device may generate new line information related to a curvature according to reference numeral 814 based on information identified based on a first target point identified based on a first target time point (e.g., a time point 0.4 seconds after the first time point).

For example, the travel control device may generate new line information related to a curvature according to reference numeral 816 based on information identified based on a second target point identified based on a second target time point (e.g., a time point 0.6 seconds after the first time point).

For example, the travel control device may generate new line information related to a curvature according to reference numeral 818 based on information identified based on a third target point identified based on a third target time point (e.g., a time point 0.8 seconds after the first time point). The travel control device may identify a reference curvature (e.g., about −1.4) at a second time point, which is a time point immediately before the first time point, (or the first time point) among the identified line information, and identify line information with the smallest difference from the reference curvature. According to FIG. 8, line information according to reference numeral 816 may be referred to as having the smallest difference. The travel control device may generate new line information using the line information according to reference numeral 816.

Referring to reference numeral 820, the travel control device may acquire information on a curvature change rate according to reference numeral 822 using the sensor.

For example, the travel control device may identify that, in a section between 110 ms and 115 ms, a second peak section (e.g., the second peak section 325 in FIG. 3) in which the curvature change rate acquired by the travel control device using the sensor momentarily increases has occurred.

For example, the travel control device may identify at least one target candidate to apply the compensation algorithm for the peak phenomenon. As the at least one target candidate, at least one target point candidate that the host vehicle is expected to reach within a specified time duration range (e.g., a time duration range from a time point 0.4 seconds after to 0.8 seconds after the first time point) after a preset time duration (e.g., 0.4 seconds) from the first time point at which the peak phenomenon has occurred may be identified.

For example, the travel control device may generate new line information related to a curvature according to reference numeral 824 based on information identified based on the first target point identified based on the first target time point (e.g., the time point 0.4 seconds after the first time point).

For example, the travel control device may generate new line information related to a curvature according to reference numeral 826 based on information identified based on the second target point identified based on the second target time point (e.g., the time point 0.6 seconds after the first time point).

For example, the travel control device may generate new line information related to a curvature according to reference numeral 828 based on information identified based on the third target point identified based on the third target time point (e.g., the time point 0.8 seconds after the first time point).

The travel control device may identify a reference curvature change rate (e.g., about 0.5) at the second time point, which is the time point immediately before the first time point, (or the first time point) among the identified line information, and identify line information with the smallest difference from the reference curvature change rate. According to FIG. 8, line information according to reference numeral 828 may be referred to as having the smallest difference. The travel control device may generate new line information using the line information according to reference numeral 828.

If the at least one target candidate according to reference numeral 810 and reference numeral 820 is identified, the travel control device may preferentially generate calibrated line information based on a target point (e.g., the second target point) identified via logic according to reference numeral 810. Accordingly, the travel control device may generate new line information for a partial section of the line.

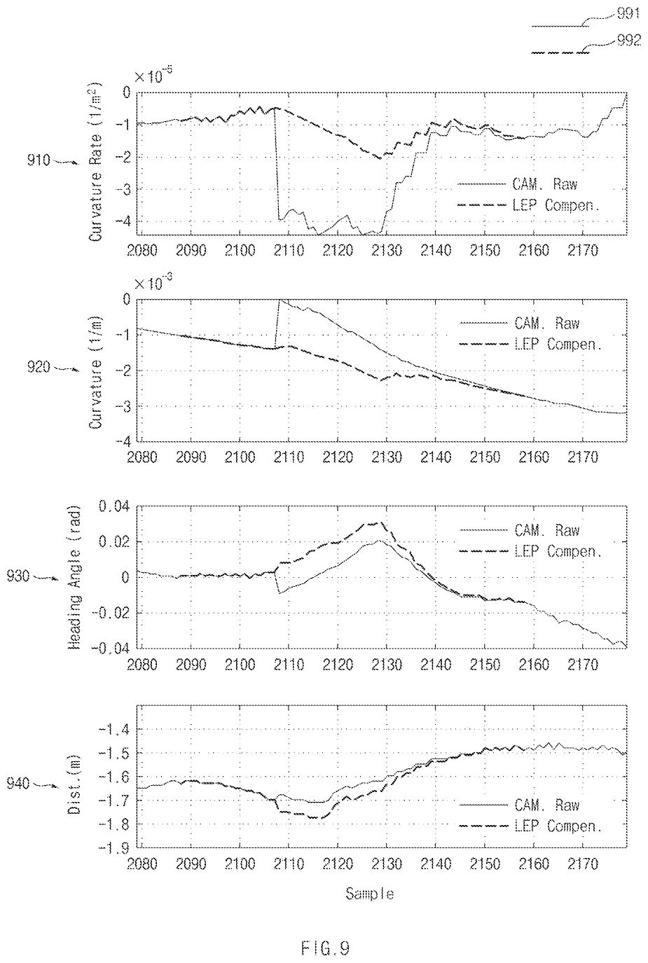

FIG. 9 illustrates conceptual diagrams of operation of a travel control device.

A travel control device (e.g., the travel control device 100 in FIG. 1) may generate new line information for a partial section of a line via a compensation algorithm.

Referring to reference numeral 910 to reference numeral 940, the travel control device may identify line recognition results including information (e.g., a graph according to reference numeral 991) acquired using a sensor. For example, the travel control device may identify at least one of a curvature change rate according to reference numeral 991 in a graph shown in reference numeral 910, a curvature according to reference numeral 991 in a graph shown in reference numeral 920, a heading error according to reference numeral 991 in a graph shown in reference numeral 930, or a lateral error according to reference numeral 991 in a graph shown in reference numeral 940, or any combination thereof.

For example, when at least some (e.g., the curvature and the curvature change rate) of the acquired information satisfies a specified condition, the travel control device may perform correction for a partial section of the information via a compensation algorithm.

For example, the travel control device may activate the compensation algorithm to identify information corresponding to a graph according to reference numeral 992 and generate new line information for the partial section of the line based on the identified information. The travel control device may perform travel control of the host vehicle based on the new line information.

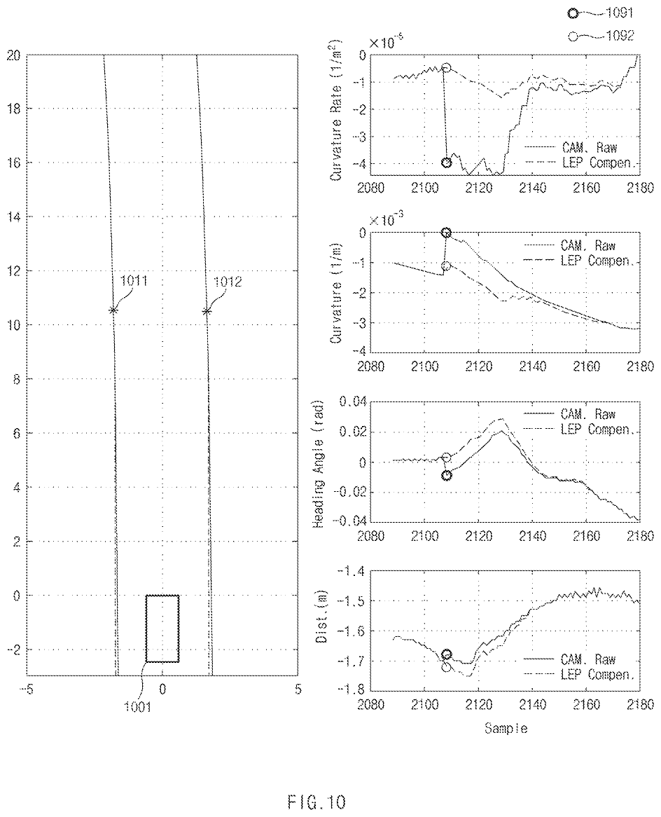

FIG. 10 illustrates conceptual diagrams of operation of a travel control device.

A travel control device (e.g., the travel control device 100 in FIG. 1) may generate new line information for a partial section of a line via a compensation algorithm.

For example, the travel control device may identify a time point 1091 at which a peak phenomenon maximally occurs.

For example, the travel control device may identify a time point 1092 at which the peak phenomenon has occurred based on a change in at least some of the information acquired using the sensor.

For example, the travel control device may identify information at a target point that is used to generate the new line information.

For example, the travel control device may identify a first point 1011 and a second point 1012 corresponding to the target point of the lines. For example, the first point 1011 and the second point 1012 may be points corresponding to a left line and a right line of the road at the target point, respectively.

For example, the travel control device may generate the new line information using at least some of the information on the road at the target point, and control a host vehicle 1001 based on the generated line information.

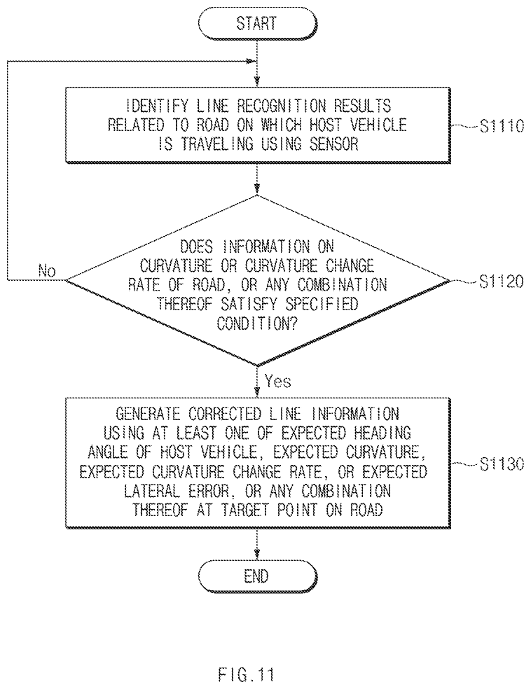

FIG. 11 is a flowchart of a travel control method.

According to one implementation, a travel control device (e.g., the travel control device in FIG. 1) may perform operations disclosed in FIG. 11. For example, at least some of components (e.g., the sensor 110, the memory 120, and/or the controller 130 in FIG. 1) included in the travel control device may be set to perform the operations in FIG. 11.

Operations S1110 to S1130 may be performed sequentially, but are not necessarily performed sequentially. For example, an order of each operation may be changed, and at least two operations may be performed in parallel with each other. Additionally, content corresponding to or redundant to the content described above with respect to FIG. 11 may be briefly described or omitted.

The travel control device may identify the line recognition results related to the road on which the host vehicle is traveling using the sensor (S1110).

The travel control device may determine whether the information on the curvature or the curvature change rate of the road, or any combination thereof satisfies the specified condition (S1120).

For example, the travel control device may determine whether the information acquired in S1110 satisfies the first condition in which the curvature change rate increases and the curvature decreases, or the curvature change rate decreases and the curvature increases and the second condition in which the curvature changes by the value equal to or greater than the critical value are satisfied.

For example, when the information on the curvature or the curvature change rate of the road, or any combination thereof is identified as satisfying the specified condition (e.g., S1120-Yes), the travel control device may perform step S1130.

For example, when the information on the curvature or the curvature change rate of the road, or any combination thereof is identified as not satisfying the specified condition (e.g., S1120-No), the travel control device may repeatedly perform step S1110.

The travel control device may generate the calibrated line information using at least one of the expected heading angle of the host vehicle, the expected curvature, the expected curvature change rate, or the expected lateral error, or any combination thereof at the target point on the road (S1130).

For example, the travel control device may perform the travel control for the host vehicle using at least some of the calibrated line information.

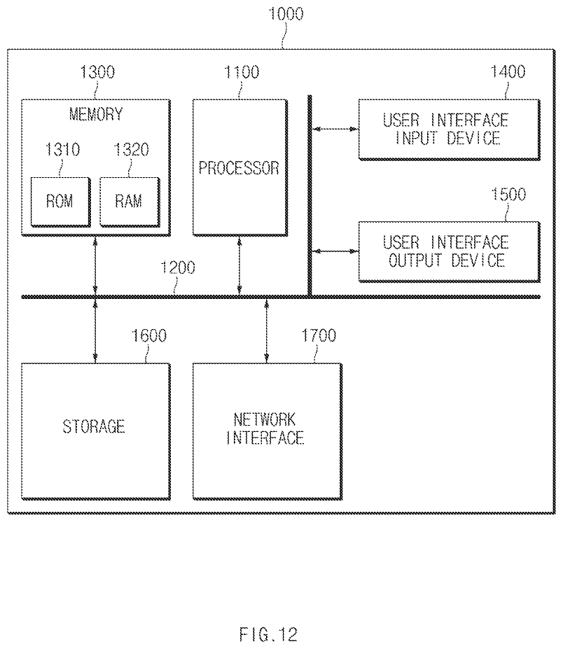

FIG. 12 illustrates a computing system related to a travel control method.

With reference to FIG. 12, a computing system 1000 related to the travel control method may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the one or more example embodiments disclosed in the present disclosure are not intended to limit the technical idea of the present disclosure but to illustrate the present disclosure, and the scope of the technical idea of the present disclosure is not limited by the example embodiments. The scope of the present disclosure should be construed as being covered by the scope of the appended claims, and all technical ideas falling within the scope of the claims should be construed as being included in the scope of the present disclosure.

Effects of the device and the method for controlling the travel according to the present disclosure are as follows.

One or more example embodiments of the present disclosure may provide the user with a more adaptive and serviceable travel experience by ensuring the continuity before and after the peak phenomenon occurs and executing the compensation algorithm in the polynomial graph corresponding to the line.

In addition, according to the present disclosure, the travel control device that identifies the line with the polynomial for the travel control may provide the line recognition results with high accuracy by identifying that the peak phenomenon occurs in some of the coefficients of the polynomial and appropriately compensating for the same.

Additionally, according to the present disclosure, when the problem such as the decrease in the accuracy of the line recognition results occurs, at least some of the line recognition results are calibrated via the correction algorithm without releasing the travel control to lower a frequency of the control release, so that a travel control function with improved marketability may be provided.

In addition, various effects that are directly or indirectly identified through the present document may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device comprising:
a sensor;
memory storing instructions; and
a controller operatively connected to the sensor and the memory,
wherein the instructions, when executed by the controller, cause the device to:
obtain, via the sensor, a line recognition result associated with a road on which a vehicle is traveling;
determine, based on the line recognition result, whether information, which comprises at least one of a curvature of the road or a curvature change rate of the road, satisfies a specified condition; and
based on the information satisfying the specified condition, generate calibrated line information using an expected curvature change rate, wherein the expected curvature change rate is determined based on:
the curvature change rate, and
at least one of an expected heading angle of the vehicle at a target point on the road, an expected curvature at the target point, or an expected lateral error at the target point.

2. The device of claim 1, wherein the specified condition comprises:
a first condition comprising one of:
an increase in the curvature change rate and a decrease in the curvature, or
a decrease in the curvature change rate and an increase in the curvature, and
a second condition comprising the curvature changing by more than a threshold value.

3. The device of claim 1, wherein the instructions, when executed by the controller, further cause the device to:
control, during a time duration after a time associated with the information, movement of the vehicle based on the line recognition result and the calibrated line information.

4. The device of claim 1, wherein the instructions, when executed by the controller, further cause the device to:
determine at least one target point candidate that the vehicle is expected to reach within a time duration after a time associated with the information; and
determine the expected curvature change rate at the target point, wherein the target point is one of the at least one target point candidate.

5. The device of claim 4, wherein the instructions, when executed by the controller, further cause the device to:
determine, among curvatures included in the line recognition result, a reference curvature associated with a second time before the time associated with the information; and
determine, among the at least one target point candidate, the target point such that a difference between a calibrated curvature at a time point when the specified condition is satisfied and the reference curvature is smallest.

6. The device of claim 1, wherein the instructions, when executed by the controller, further cause the device to:
determine, based on curvature change rates included in the line recognition result, a first curvature change rate at a time associated with the information; and
determine, based on the curvature change rates included in the line recognition result, a second curvature change rate representing an overall curvature change rate of the road;
determine, based on at least one of the first curvature change rate, the second curvature change rate, or a weight of each of the first curvature change rate and the second curvature change rate, the expected curvature change rate for a time duration starting at the time associated with the information.

7. The device of claim 6, wherein the weight of each of the first curvature change rate and the second curvature change rate comprises a first weight of the first curvature change rate, wherein the first weight decreases during the time duration.

8. The device of claim 1, wherein the instructions, when executed by the controller, further cause the device to:
determine, via the sensor, a travel speed of the vehicle; and
determine the target point based on at least one of the travel speed or a predetermined time duration.

9. A method comprising:
obtaining, by a controller and via a sensor, a line recognition result associated with a road on which a vehicle is traveling;
determining, by the controller and based on the line recognition result, whether information, which comprises at least one of a curvature of the road or a curvature change rate of the road, satisfies a specified condition; and
based on the information satisfying the specified condition, generating, by the controller, calibrated line the expected curvature change rate is determined based on:
the curvature change rate, and
at least one of an expected heading angle of the vehicle at a target point on the road, an expected curvature at the target point, or an expected lateral error at the target point.

10. The method of claim 9, wherein the specified condition comprises:
a first condition comprising one of:
an increase in the curvature change rate and a decrease in the curvature, or
a decrease in the curvature change rate and an increase in the curvature, and
a second condition comprising the curvature changing by more than a threshold value.

11. The method of claim 9, further comprising:
controlling, by the controller and during a time duration after a time associated with the information, movement of the vehicle based on the line recognition result and the calibrated line information.

12. The method of claim 9, further comprising:
determining, by the controller, at least one target point candidate that the vehicle is expected to reach within a time duration after a time associated with the information; and
determining, by the controller, the expected curvature change rate at the target point, wherein the target point is one of the at least one target point candidate.

13. The method of claim 12, further comprising:
determining, by the controller and among curvatures included in the line recognition result, a reference curvature associated with a second time before the time associated with the information; and
determining, by the controller and among the at least one target point candidate, the target point such that a difference between a calibrated curvature at a time point when the specified condition is satisfied and the reference curvature is smallest.

14. The method of claim 9, further comprising:
determining, by the controller and based on curvature change rates included in the line recognition result, a first curvature change rate at a time associated with the information; and
determining, based on the curvature change rates included in the line recognition result, a second curvature change rate representing an overall curvature change rate of the road;
determining, by the controller and based on at least one of the first curvature change rate, the second curvature change rate, or a weight of each of the first curvature change rate and the second curvature change rate, the expected curvature change rate for a time duration starting at the time associated with the information.

15. The method of claim 14, wherein the weight of each of the first curvature change rate and the second curvature change rate comprises a first weight of the first curvature change rate, wherein the first weight decreases during the time duration.

16. A computer-readable medium storing instructions that, when executed, cause:
obtaining, by a controller and via a sensor, a line recognition result associated with a road on which a vehicle is traveling;
determining, by the controller and based on the line recognition result, whether information, which comprises at least one of a curvature of the road or a curvature change rate of the road, satisfies a specified condition; and
based on the information satisfying the specified condition, generating, by the controller, calibrated line the expected curvature change rate is determined based on:
the curvature change rate, and
at least one of an expected heading angle of the vehicle at a target point on the road, an expected curvature at the target point, or an expected lateral error at the target point.

17. The computer-readable medium of claim 16, wherein the specified condition comprises:
a first condition comprising one of:
an increase in the curvature change rate and a decrease in the curvature, or
a decrease in the curvature change rate and an increase in the curvature, and
a second condition comprising the curvature changing by more than a threshold value.

18. The computer-readable medium of claim 16, wherein the instructions, when executed, further cause:
controlling, by the controller and during a time duration after a time associated with the information, movement of the vehicle based on the line recognition result and the calibrated line information.

19. The computer-readable medium of claim 16, wherein the instructions, when executed, further cause:
determining, by the controller, at least one target point candidate that the vehicle is expected to reach within a time duration after a time associated with the information; and
determining, by the controller, the expected curvature change rate at the target point, wherein the target point is one of the at least one target point candidate.

20. The computer-readable medium of claim 19, wherein the instructions, when executed, further cause:
determining, by the controller and among curvatures included in the line recognition result, a reference curvature associated with a second time before the time associated with the information; and
determining, by the controller and among the at least one target point candidate, the target point such that a difference between a calibrated curvature at a time point when the specified condition is satisfied and the reference curvature is smallest.
